(19) United States
(12) Patent Application Publication
(10) Pub. No.: US 2011/0172871 A1
(43) Pub. Date: Jul. 14, 2011

(54) SYSTEM AND METHOD FOR MEASURING ENERGY EFFICIENCY IN VEHICLES

(76) Inventors: WILLIAM DAVID HALL, STAMFORD, CT (US); LAURENCE VIGEANT-LANGLOIS, STAMFORD, CT (US)

(21) Appl. No.: 12/984,696

(22) Filed: Jan. 5, 2011

Related U.S. Application Data
(60) Provisional application No. 61/293,228, filed on Jan. 8, 2010.

(51) Int. Cl. G06F 17/00; B60Q 1/00

(52) U.S. Cl. 701/29; 340/439

(57) ABSTRACT

A system for measuring energy efficiency in a vehicle includes means for measuring instantaneous consumption of stored energy in the vehicle, means for measuring the change of the sum of potential and kinetic energy over time, a processor and an application. The application includes computer-implemented instructions for calculating the energy efficiency of the vehicle with the processor by calculating total energy used per unit distance traveled. The total energy includes potential energy, kinetic energy and stored energy. The total energy is calculated based on the measured instantaneous stored energy consumption and the measured change of the sum of potential and kinetic energy over time. The system optionally provides data to a cruise control, autopilot or other system to automate optimization of the vehicle's speed, acceleration and deceleration.

### CROSS REFERENCE TO RELATED CO-PENDING APPLICATIONS

This application claims the benefit of U.S. provisional application Ser. No. 61/293,228 filed on Jan. 8, 2010 and entitled IMPROVED SYSTEM AND METHOD FOR MEASURING ENERGY EFFICIENCY IN GROUND TRANSPORTATION VEHICLES which is commonly assigned and the contents of which are expressly incorporated herein by reference.

### FIELD OF THE INVENTION

The present invention relates to an improved system and method for measuring energy efficiency in vehicles and in particular to a system and a method that measures distance traveled per unit energy consumed.

### BACKGROUND OF THE INVENTION

More than a quarter of the United States' energy consumption is attributable to transportation, resulting in more than one third of the country's CO₂ emissions. Ground transportation in particular is a major contributor to energy consumption, hence a key area of relevance, focus and description of the invention. Nevertheless, the system and method described herein do apply to many other types of vehicles whereas the energy available on-board is limited and energy management applies, including also aircraft, watercraft, spacecraft and submarines.

Over 60% of the transportation-related energy consumption is consumed in passenger and other two-axle, four-tire vehicles, and another 18% of it is consumed in trucks and buses. Energy consumption in a vehicle depends upon the inherent fuel efficiency of the vehicle and upon the vehicle operator's driving behavior in view of road traffic, road conditions and topography. Although surface vehicles have increasingly been built with greater inherent features that improve fuel efficiency and reduce environmental impact, little has been done to improve how efficiently these vehicles are operated in view of the actual road traffic, conditions and topography. Many companies and drivers desire to operate their vehicles efficiently but lack the necessary knowledge and information about the vehicle to do so effectively.

To support the operator's management of fuel burn, most current production vehicles include one or more of three types of instrumentation: i) an “instantaneous mileage” gauge with information about the estimated distance traveled per unit fuel burn, such as that presented in U.S. Pat. No. 4,062,230, ii) a near-real-time reading of “distance remaining” from the remaining fuel or battery charge at the current rate of fuel usage or charge usage; and iii) an average fuel efficiency gauge with information about the average mileage attained over the course of a trip, since refilling the fuel tank, or over some other relatively long time period.

None of these gauges is very helpful to an operator attempting to maximize his mileage by adjusting his driving behavior. Consider, for instance, using either the instantaneous fuel efficiency gauge or the distance-to-go reading to attempt to choose the most efficient cruising speed. One could in theory drive at different speeds and choose the speed that the gauge indicated resulted in the highest mileage per gallon or mileage remaining However, variations in the instantaneous readout due to slight road inclines, declines, acceleration or deceleration result in significant changes in the mileage readout that typically overwhelm the efficiency reading the driver is trying to obtain. As a result, and without any additional information, a significant amount of patience and a dangerous amount of focus on the gauge (while the driver ought to watch the road instead) is required to reach an error-prone conclusion about the most efficient speed to drive.

Similarly, one can try to use the average fuel efficiency gauge over a series of trips, adjusting driving behavior (for instance, cruising speed) on each trip, and choose the behavior that maximizes trip mileage. The problems with this approach are multiple, including the difficulty of maintaining a consistent driving behavior over the trip despite traffic and other road condition related variables, as well as differences in vehicle performance induced by temperature, winds, tire pressures, or a multitude of other factors that may vary between successive trips.

Accordingly, there is a need for an improved system and method for measuring real-time energy efficiency in vehicles.

### SUMMARY OF THE INVENTION

In general, in one aspect, the invention features a system for measuring energy efficiency in a vehicle including means for measuring instantaneous consumption of stored energy in the vehicle, means for measuring the change of the sum of potential and kinetic energy over time, a processor and an application. The application includes computer implemented instructions for calculating the energy efficiency of the vehicle with the processor by calculating total energy used per unit distance traveled. The total energy includes potential energy, kinetic energy and stored energy. The total energy is calculated based on the measured instantaneous stored energy consumption and the measured change of the sum of potential and kinetic energy over time.

Implementations of this aspect of the invention may include one or more of the following features. The means for measuring the change of the sum of potential and kinetic energy over time include means for measuring the vehicle speed or distance and time traveled, and means for measuring the vehicle acceleration. The energy efficiency of the vehicle is calculated based on equation: EnergyEff=(f/v)−ma, where f is the instantaneous stored energy consumption, v is the measured vehicle speed, a is the measured vehicle acceleration and m is the vehicle mass. The means for measuring the vehicle acceleration comprise an accelerometer mounted on the vehicle and being oriented along the longitudinal axis of the vehicle. The means for measuring the vehicle speed include means for measuring the rotational speed of a wheel of the vehicle or means for measuring the rotational speed of an impeller designed to detect the speed of the vehicle through water or air or means for measuring the dynamic ram air pressure generated by the vehicle's motion through air or a Global Positioning System (GPS) receiver. The means for measuring the change of the sum of potential and kinetic energy over time include means for measuring the vehicle speed or distance and time traveled and means for measuring altitude. In this case, the energy efficiency of the vehicle is calculated based on equation: EnergyEff=−1/v (dS/dt+(d(mgh)/dt)+(d(1/2 mv²)/dt)), where dS/dt is the instantaneous stored energy consumption, h is the measured altitude, v is the measured vehicle speed, m is the vehicle mass and g is the gravitational acceleration. The means for measuring altitude include one of a barometric altimeter, a pressure sensor or a GPS receiver. The means for measuring altitude include means for determining the location of the vehicle and a database comprising elevation information as a function of location. The system further includes an output device for displaying the calculated energy efficiency data of the vehicle in real time to the vehicle operator. The output device comprises one of a gauge, a display or a sound producing device. The output device further displays output data comprising at least one of “recommended speed to go”, “progress made good”, “mpg-made-good”, “estimated gallons to destination”, “instantaneous mileage”, “distance remaining”, or “average mileage per trip or segment”. The system further includes means for storing the output data for post-processing and means for transmitting the output data to a dispatch system for optimizing a fleet operation. The system further includes a vehicle control system comprising means for controlling the vehicle in real time. The system further includes means for transmitting the calculated energy efficiency data to the vehicle control system for controlling the vehicle in real time based on the calculated energy efficiency data. The system further includes means for storing the calculated energy efficiency data for post-processing. The stored energy includes at least one of chemical, nuclear, thermal, electrical, wind energy, gasoline fuel, natural gas, petroleum, diesel, ethanol, or biological energy components. Each energy component is multiplied by a conversion factor and the result is added to the total energy. The conversion factor used for each stored energy component is representative of typically achieved conversion efficiency from that energy component to kinetic energy. The conversion factor used for each stored energy component is representative of best-case conversion efficiency from that energy component to kinetic energy. The conversion factor used for each stored energy component is an estimate of the conversion efficiency from that energy component to kinetic energy. The system further includes input means for entering stored energy cost data, operator's time cost data or the ratio of the operator's time cost data to the stored energy stored data.

In general, in another aspect, the invention features a method for measuring energy efficiency in a vehicle including the following steps. First, measuring instantaneous consumption of stored energy in the vehicle. Next, measuring the change of the sum of potential and kinetic energy over time. Next, providing a processor and an application comprising computer implemented instructions for calculating the energy efficiency of the vehicle. Next, calculating the energy efficiency of the vehicle with the processor by calculating total energy used per unit distance traveled. The total energy includes potential energy, kinetic energy and stored energy and the total energy is calculated based on the measured instantaneous stored energy consumption and the measured change of the sum of potential and kinetic energy over time.

Among the advantages of this invention may be one or more of the following. The present provides an instantaneous mileage gauge that automatically compensates for the primary factors that lead to inaccurate measurements on current production mileage gauges. Rather than providing a measurement of distance traveled per unit of fuel burned, the present invention measures distance traveled per unit of energy consumed. The amount of consumed energy includes kinetic, potential and stored energy (such as fuel). Contrary to that, most prior art solutions account only for stored energy. U.S. Pat. No. 6,411,888 describes a method for measuring kinetic energy to calculate energy loss through braking, but does not include potential and stored energy. While climbing a hill at constant speed, the vehicle is converting some stored energy into potential energy as well as using stored energy to overcome friction and drag. In this situation the traditional mileage gauge on a fuel-powered vehicle would present a low miles-per-gallon measurement, whereas the system of the present invention would reflect only the fuel used to overcome friction and drag which is a more useful quantity to the driver. Similarly, current production gas mileage gauges indicate excellent mileage while traveling downhill, even if the driver is in an inefficient gear or applying brakes. The present invention would indicate that mileage could be improved in such situations.

The invention also includes the capability to store parameterized energy efficiency information for later download and analysis. The stored energy efficiency information can also be used to solve for the speed that minimizes cost along a route, where energy used is one component of cost, for instance in a cruise control that looks ahead along the route's elevation map, traffic controls, speed limits and congestion to plan efficient power and speed trajectories along the route.

The details of one or more embodiments of the invention are set forth in the accompanying drawings and description below. Other features, objects and advantages of the invention will be apparent from the following description of the preferred embodiments, from the drawings and from the claims.

### BRIEF DESCRIPTION OF THE DRAWINGS

Referring to the figures, wherein like numerals represent like parts throughout the several views:

FIG. 1 is a schematic view of the first embodiment of the invention;

FIG. 2 is a schematic view of the second embodiment of the invention;

FIG. 3 is a schematic view of the third embodiment of the invention; and

FIG. 4 is a schematic view of a fourth embodiment of the invention.

### DETAILED DESCRIPTION OF THE INVENTION

The present invention describes a system and a method that computes energy used by a vehicle per unit of distance traveled, or trivially the inverse, distance traveled per unit of energy used. The calculation takes into consideration the entire amount of energy consumed including potential energy, kinetic energy and stored energy.

Four embodiments of the invention are described here, any of which may be preferable under different circumstances: In the first embodiment, an energy efficiency gauge uses the vehicle's speed, acceleration and stored energy consumption to calculate the energy used. In the second embodiment, an energy efficiency gauge uses the vehicle's speed, altitude and stored energy consumption to calculate the energy used. In the third embodiment, an energy efficiency gauge uses the vehicle's speed, altitude, acceleration and stored energy consumption, from a variety of sources and/or in a variety of potentially redundant combinations to calculate the energy used. The fourth embodiment describes an efficiency measurement system based on a portable handheld device.

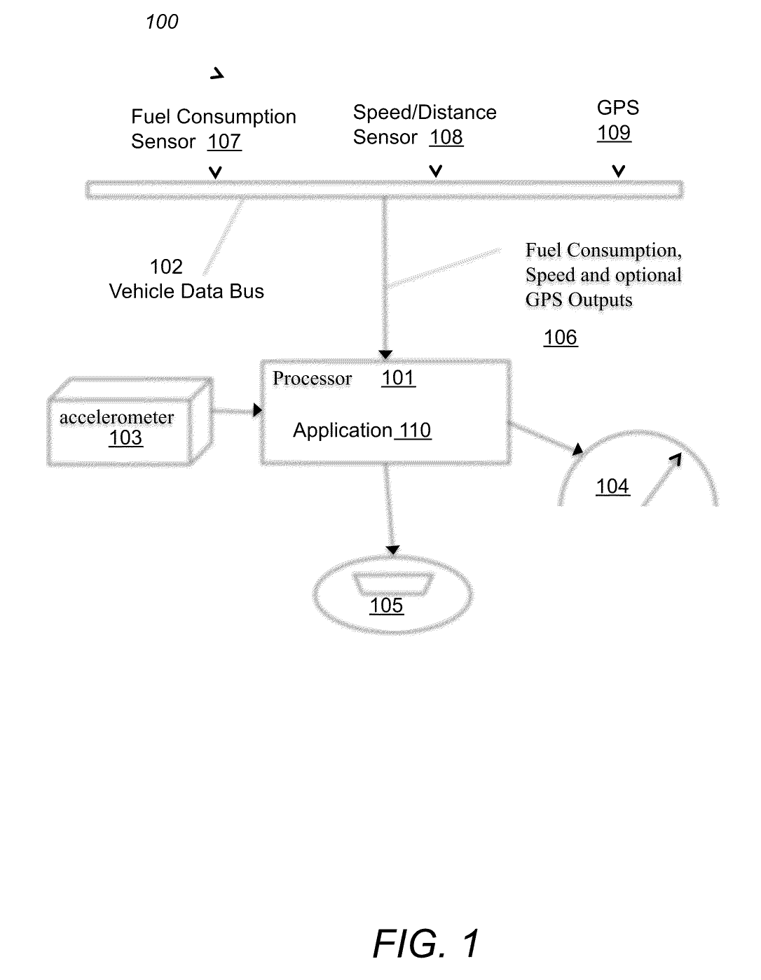

Referring to FIG. 1, a system 100 for measuring energy efficiency in vehicles includes a processor 101 or other circuitry designed to perform the required calculations, a vehicle data bus 102, an accelerometer 103, a gauge 104, a sound producing device 105, fuel consumption sensor 107, distance/speed sensor 108, GPS 109 and application 110. Processor 101 receives fuel consumption data and speed or distance data 106 from the vehicle's data bus 102 plus optionally information from a navigation system such as GPS. The fuel consumption data, distance/speed data and GPS data are provided to the vehicle bus 102 by the fuel consumption sensor 107, distance/speed sensor 108, and the GPS 109, respectively. If appropriate, the calculation device 101 receives these data directly from some or all of the corresponding sensors (i.e., fuel consumption sensor 107, distance/speed sensor 108, and GPS 109) instead of collecting it from the data bus 102. Processor 101 also receives information from the accelerometer 103 fixed to the vehicle frame. The vehicle acceleration data capture the proper acceleration of the vehicle, which includes the gravity component when the vehicle is inclined. The proper acceleration of the vehicle is measured from the longitudinal-axis component of the output of the accelerometer. In one example, accelerometer 103 is preferably a 3-axis accelerometer. In other examples, a single-axis or dual-axis accelerometer could provide similar results if it were installed with careful alignment. The calculation device 101 uses application 110 to calculate the vehicle energy efficiency and sends the result of this calculation to gauge 104 that the vehicle operator can see and/or to the sound-producing device 105 that the operator can hear.

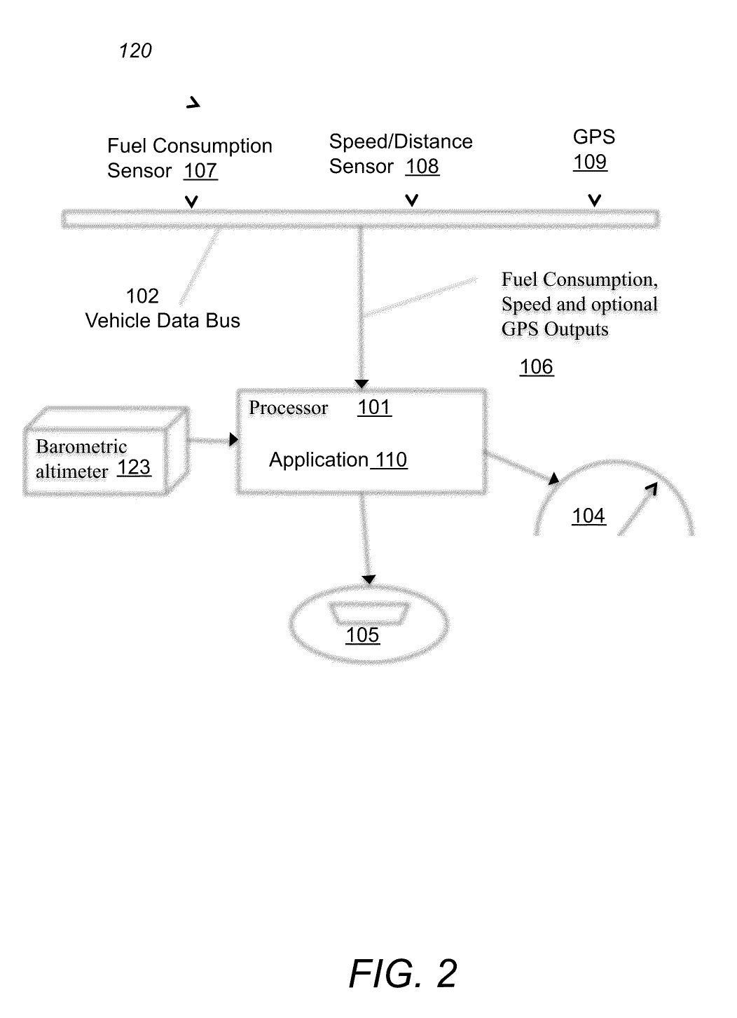

Referring to FIG. 2 in a second embodiment, a system 120 for measuring energy efficiency in vehicles includes a processor 101 or other circuitry designed to perform the required calculations, a vehicle data bus 102, a barometric altimeter 123, a gauge 104, a sound producing device 105, fuel consumption sensor 107, distance/speed sensor 108, GPS 109 and application 110. Processor 101 receives fuel consumption data and speed or distance data 106 from the vehicle's data bus 102 plus optionally information from a navigation system such as GPS. The fuel consumption data, distance/speed data and GPS data are provided to the vehicle bus 102 by the fuel consumption sensor 107, distance/speed sensor 108, and the GPS 109, respectively. If appropriate, the calculation device 101 receives these data directly from some or all of the corresponding sensors (i.e., fuel consumption sensor 107, distance/speed sensor 108, and GPS 109) instead of collecting it from the data bus 102. Processor 101 also receives information from the barometric altimeter 123 or other means of calculating or measuring altitude. The calculation device 101 uses application 110 to calculate the vehicle energy efficiency and sends the result of this calculation to gauge 104 that the vehicle operator can see and/or to the sound-producing device 105 that the operator can hear.

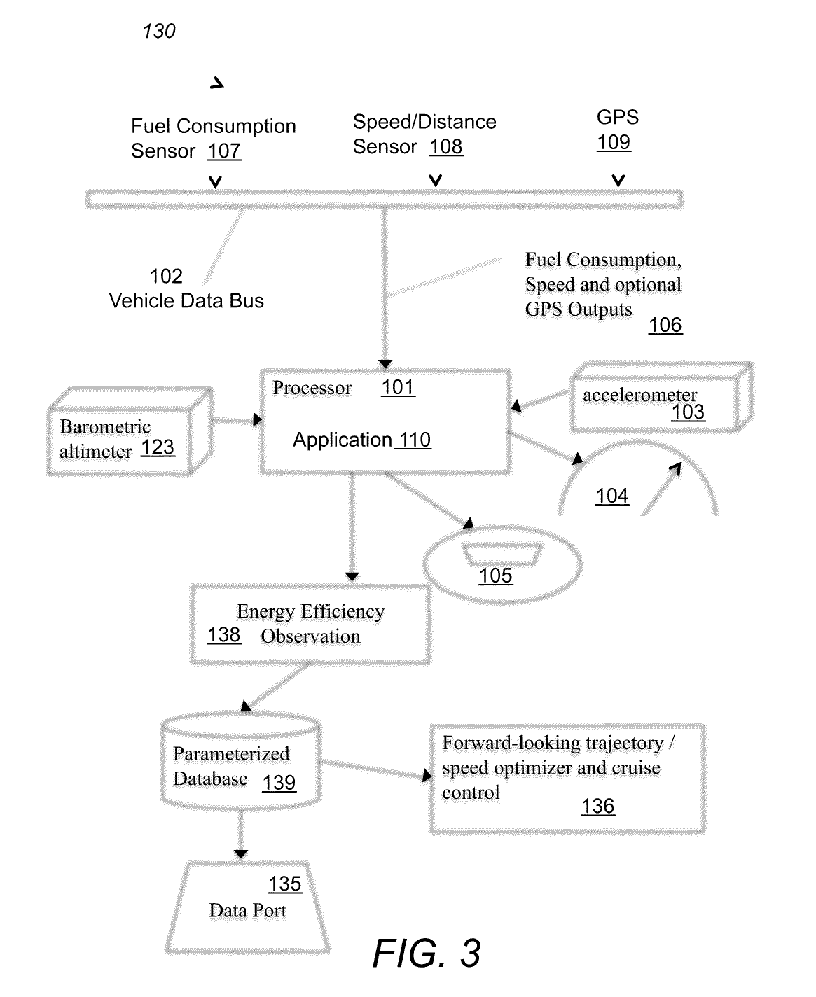

Referring to FIG. 3 in a third embodiment, a system 130 for measuring energy efficiency in vehicles includes a processor 101 or other circuitry designed to perform the required calculations, a vehicle data bus 102, a barometric altimeter 123, an accelerometer 103, a gauge 104, a sound producing device 105, a fuel consumption sensor 107, a distance/speed sensor 108, GPS 109 and application 110. System 130 also includes energy efficiency observation data 138, database 139, data port 135 and a trajectory/speed optimizer and cruise control system 136. Processor 101 receives fuel consumption data and speed or distance data 106 from the vehicle's data bus 102 plus optionally information from a navigation system such as GPS 109. The fuel consumption data, distance/speed data and GPS data are provided to the vehicle bus 102 by the fuel consumption sensor 107, distance/speed sensor 108, and the GPS 109, respectively. If appropriate, the calculation device 101 receives these data directly from some or all of the corresponding sensors (i.e., fuel consumption sensor 107, distance/speed sensor 108, and GPS 109) instead of collecting it from the data bus 102. Processor 101 also receives information from the barometric altimeter 123 or other means of calculating or measuring altitude. Processor 101 also receives information from the accelerometer 103. The calculation device 101 uses application 110 to calculate the vehicle energy efficiency 138 and sends the result of this calculation to gauge 104 that the vehicle operator can see and/or to the sound-producing device 105 that the operator can hear. In this embodiment, processor 101 provides an observation of energy efficiency data along with the values of the parameters of interest 138 to database 139. The database 139 updates its stored values according to the new information presented by the observation data 138. A plan-ahead cruise control and trajectory optimization system 136 uses the information stored in the database 139 to control the vehicle's speed and power in a way to minimize cost over the desired route. The system also optionally contains a data port 135 over which data from the database can be retrieved or updated. Application 110 provides the instructions for calculating the energy efficiency of the vehicle according to this invention.

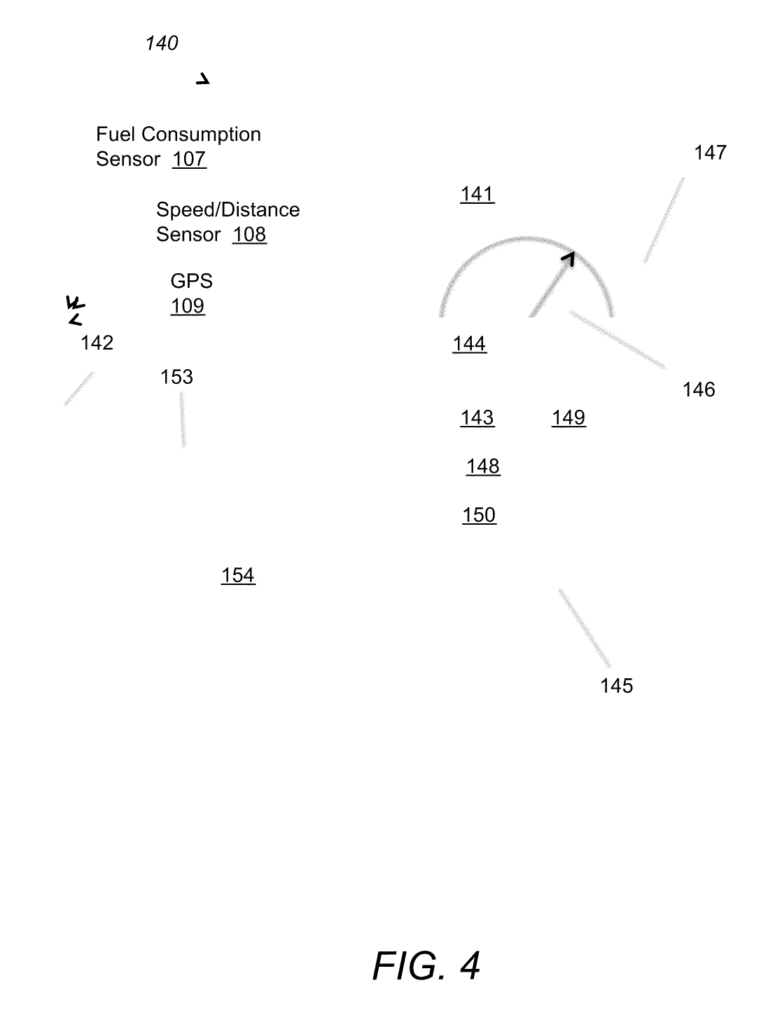

Referring to FIG. 4, in a fourth embodiment, a system 140 for measuring energy efficiency in vehicles is implemented in a portable handheld computing device 141. In one example, handheld computing device 141 is an iPhone. In other examples handheld computing device 141 is an iPad, iPod, a Smartphone or a personal digital assistant, among others. Handheld computing device 141 includes a display 144, a processor 148 or other circuitry designed to perform the required calculations, accelerometers 143, a GPS 149, and an application 150. Handheld computing device 141 is mounted to the vehicle chassis via mounts 147 and receives power and data from the vehicle data bus 142 via a plug-in interface 145. Plug-in interface 145 is connected to the vehicle data bus 142 via the vehicle's On-Board-Diagnostics (OBD-2) port 153 and an interface electronics box 154 that is plugged into the OBD-2 port. Application 150 is used to calculate the vehicle energy efficiency as described below and to render a graphical depiction 146 of the calculation result so that the vehicle operator can see the instantaneous energy efficiency results of his actions.

Central to the present invention is the calculation of total energy used per unit of distance. To calculate energy used per unit of distance in a surface vehicle, we find it most convenient to express it as a function of the change in the total energy available to the system, Ea, per unit of time, divided by speed, as follows:

$$\begin{matrix}EnergyUsePerUnitDistance = - \frac{d {E}_{a}}{d x} \\ = - \frac{d {E}_{a}}{d t} \frac{d t}{d x} \\ = - \frac{d {E}_{a}}{v d t}\end{matrix} \qquad ( 1 )$$

where Ea represents the energy available to the vehicle, x represents distance down the route of travel and v represents the vehicle's speed. Energy can be broken into the components of stored energy, S, potential energy, P, and kinetic energy, K, as follows:

E=S+P+K (2)

However, because there is inherent inefficiency, unavoidable regardless of driving technique, in converting the stored energy into mechanical energy, we prefer to measure accessible energy, E′:

E′=ηS+P+K (3)

Where η represents the relevant efficiency of the process of converting stored energy to mechanical energy, such that ηS represents the mechanical work that may be reasonably produced from the stored energy S. For instance, η may be set to a value such that ηS represents the work accomplishable at the most efficient brake specific fuel consumption of the internal combustion engine of a conventional vehicle, or it may be set to a target efficiency typically realized, realized during recent operation or otherwise realized. Alternatively, one can use an η of 1, in which case the system measures pure energy consumption. To simplify the notation, we will omit η from the rest of this discussion, but it can be added trivially by multiplying stored energy use by it in the final equations.

The measurement of available power for the system dEa/dt can be accomplished by taking derivatives of Equation (2) as follows:

$$\frac{d {E}_{a}}{d t} = \frac{d S}{d t} + \frac{d P}{d t} + \frac{d K}{d t} \qquad ( 4 )$$

dS/dt can be inferred from the rate of fuel consumption, the electrical current, or other such measurement as is typically available on the vehicle data bus. The quantities dP/dt and dK/dt can be calculated in a number of ways. For instance, with a measurement of vehicle speed, v, and a measurement from an accelerometer oriented along the longitudinal axis of the vehicle, a, the sum dP/dt+dK/dt can be derived. Consider that the sum can be related to the altitude h and speed v of the vehicle, along with the vehicle's mass m and the gravitational acceleration g (which is approximately 9.8 m/s² on the surface of the earth) as follows:

$$\frac{d P}{d t} + \frac{d K}{d t} = \frac{d ( mgh )}{d t} + \frac{d ( \frac{1}{2} {mv}^{2} )}{d t} \qquad ( 5 )$$

For a vehicle climbing an incline of angle α with respect to horizontal, equation (5) can be represented thus:

$$\frac{d P}{d t} + \frac{d K}{d t} = mgv sin α + mv \frac{d v}{d t} \qquad ( 6 )$$

However, the right-hand side of equation (6) is equal to mva, where a represents the measurement of an accelerometer aligned in the forward direction of the vehicle. Substituting this result into equation (4) produces:

$$\frac{d {E}_{a}}{d t} = - f + mva \qquad ( 7 )$$

where f represents the instantaneous fuel consumption (or use of other stored energy source) of the vehicle. Substituting equation (7) by the vehicle speed produces the energy efficiency measurement:

$$\begin{matrix}EnergyEff = \frac{d {E}_{u}}{d x} - \frac{d {E}_{a}}{d x} \\ = \frac{f - mva}{v} \\ = \frac{f}{v} - ma\end{matrix} \qquad ( 8 )$$

Because the vehicle mass may not be precisely known, and because as explained previously we are more interested in the energy accessible from the stored energy use than the actual stored energy consumed, we in general prefer to compute and display Af/v−Ba, where A and B are parameters that are automatically or manually adjustable. This represents the first embodiment, which is shown in FIG. 1.

Similarly, the second embodiment (shown in FIG. 2) is realized by measuring the components of equation (5): h may be measured through a GPS receiver, a barometric (pressure) altimeter, a measurement of vehicle location (through GPS or similar means) converted to altitude through a terrain database and the inference that the vehicle is on the earth's (or road's) surface, or any combination of these means. v may be measured from a vehicle speed sensor, a GPS, or other speed measurement. Their rates of change may be approximated by taking the difference between successive measurements of these quantities, or through mechanical or other commonly used means of doing so.

Finally, the third embodiment (shown in FIG. 3) combines aspects of the previous two embodiments, using a combination of sensors used in the first and second embodiments and, where they provide redundant information, weighting the contributions of the redundant sensors according to the magnitude of error expected in the signals of each, as in an Extended Kalman Filter (EKF). For instance, using an accelerometer as in the first embodiment, combined with an altitude sensor as in the second embodiment, the bias of the accelerometer from measurements that are inclined relative to the road's surface rather than being perfectly parallel to it can be adjusted away through the use of the altitude information from the altitude sensor.

Regardless of the exact embodiment employed, the invention optionally includes means of storing parameterized efficiency information into a database that can be used for analysis, download and/or optimal trajectory calculations appropriate to the specific vehicle on which it is installed. At any specific operating point, defined by one or more of the parameters in the list below or similar parameters, an estimate of the vehicle's efficiency is maintained in the database and updated as new observations of efficiency become available.

TABLE 1
Measured parameters

Engine RPM
Manifold Pressure
Transmission Gear
Rate of energy conversion from Stored Energy to Mechanical Energy
(e.g., by an engine)
Vehicle Speed over ground
Vehicle Speed through air
Braking applied (true/false)
Braking pressure
Air temperature
Tire pressure
Air conditioner state
Electrical system loads (such as headlights, defrosters, radios, etc)
Vehicle drag parameter
Road condition parameter

For instance, in a simple system, the efficiency as a function of rate of energy conversion and vehicle speed when not braking might be maintained in the database. Vehicle speed might be quantized into 3-MPH buckets, energy conversion into 1-HP buckets. In such a case, if the vehicle were accelerating through 24 MPH on level ground by converting 17 HP from stored energy into mechanical power by burning fuel containing 68 HP worth of energy, then 25% (17 HP/68 HP) efficiency would be observed in the 24-27 MPH X 17 HP bucket. That efficiency observation would be factored into the efficiency information already stored in the 24-27 MPH×17 HP database entry.

In its simplest form, the efficiency data e_{d}, in the database in the appropriate cell, is replaced with (1−k)e_{d}+k eₒ, where k is a constant between 0 and 1, and eₒ represents the new efficiency observation. The resulting database table can then be used by trajectory optimization algorithms to minimize the fuel use over the route by regulating vehicle speed and power.

Several embodiments of the present invention have been described. Nevertheless, it will be understood that various modifications may be made without departing from the spirit and scope of the invention. Accordingly, other embodiments are within the scope of the following claims.

What is claimed is:

1. A system for measuring energy efficiency in a vehicle comprising:
means for measuring instantaneous consumption of stored energy in said vehicle;
means for measuring the change of the sum of potential and kinetic energy over time;
a processor; and
an application comprising computer implemented instructions for calculating the energy efficiency of the vehicle with said processor by calculating total energy used per unit distance traveled, wherein said total energy comprises potential energy, kinetic energy and stored energy and wherein said total energy is calculated based on said measured instantaneous stored energy consumption and said measured change of the sum of potential and kinetic energy over time.

2. The system of claim 1 wherein said means for measuring the change of the sum of potential and kinetic energy over time comprise:
means for measuring the vehicle speed or distance and time traveled; and
means for measuring the vehicle acceleration.

3. The system of claim 2 wherein the energy efficiency of said vehicle is calculated based on equation:
EnergyEff=(f/v)−ma
wherein f is the instantaneous stored energy consumption, v is the measured vehicle speed, a is the measured vehicle acceleration and m is the vehicle mass.

4. The system of claim 2 wherein said means for measuring the vehicle acceleration comprises an accelerometer mounted on said vehicle and being oriented along the longitudinal axis of the vehicle.

5. The system of claim 2 wherein said means for measuring the vehicle speed comprise means for measuring the rotational speed of a wheel of said vehicle.

6. The system of claim 2 wherein said means for measuring the vehicle speed comprises means for measuring the rotational speed of an impeller designed to detect the speed of said vehicle through water or air.

7. The system of claim 2 wherein said means for measuring the vehicle speed comprises means for measuring the dynamic ram air pressure generated by the vehicle's motion through air.

8. The system of claim 2 wherein said means for measuring the vehicle speed comprises a Global Positioning System (GPS) receiver.

9. The system of claim 1 wherein said means for measuring the change of the sum of potential and kinetic energy over time comprise:
means for measuring the vehicle speed or distance and time traveled; and
means for measuring altitude.

10. The system of claim 9 wherein the energy efficiency of said vehicle is calculated based on equation:
EnergyEff=−1/v(dS/dt+(d(mgh)/dt)+(d(1/2 mv²)/dt))
wherein dS/dt is the instantaneous stored energy consumption, h is the measured altitude, v is the measured vehicle speed, m is the vehicle mass and g is the gravitational acceleration.

11. The system of claim 9 wherein said means for measuring altitude comprise one of a barometric altimeter, a pressure sensor or a GPS receiver.

12. The system of claim 9 wherein said means for measuring altitude comprise means for determining the location of the vehicle and a database comprising elevation information as a function of location.

13. The system of claim 1 further comprising an output device for displaying the calculated energy efficiency data of the vehicle in real time to the vehicle operator.

14. The system of claim 13 wherein said output device comprises one of a gauge, a display or a sound producing device.

15. The system of claim 13 wherein said output device further displays output data comprising at least one of “recommended speed to go”, “progress made good”, “mpg-made-good”, “estimated gallons to destination”, “instantaneous mileage”, “distance remaining”, or “average mileage per trip or segment”.

16. The system of claim 15 further comprising means for storing said output data for post-processing and means for transmitting said output data to a dispatch system for optimizing a fleet operation.

17. The system of claim 1 further comprising a vehicle control system comprising means for controlling the vehicle in real time and wherein said system further comprises means for transmitting the calculated energy efficiency data to the vehicle control system for controlling the vehicle in real time based on the calculated energy efficiency data.

18. The system of claim 1 further comprising means for storing the calculated energy efficiency data for post-processing.

19. The system of claim 1 wherein said stored energy comprises at least one of chemical, nuclear, thermal, electrical, wind energy, gasoline fuel, natural gas, petroleum, diesel, ethanol or biological energy components.

20. The system of claim 19 wherein each energy component is multiplied by a conversion factor and the result is added to the total energy.

21. The system of claim 20 wherein the conversion factor used for each stored energy component is representative of typically achieved conversion efficiency from that energy component to kinetic energy.

22. The system of claim 20 wherein the conversion factor used for each stored energy component is representative of best-case conversion efficiency from that energy component to kinetic energy.

23. The system of claim 20 wherein the conversion factor used for each stored energy component is an estimate of the conversion efficiency from that energy component to kinetic energy.

24. The system of claim 1 further comprising input means for entering stored energy cost data, operator's time cost data or the ratio of the operator's time cost data to the stored energy stored data.

25. A method for measuring energy efficiency in a vehicle comprising:
measuring instantaneous consumption of stored energy in said vehicle;
measuring the change of the sum of potential and kinetic energy over time;
providing a processor and an application comprising computer implemented instructions for calculating the energy efficiency of the vehicle; and
calculating the energy efficiency of the vehicle with said processor by calculating total energy used per unit distance traveled, wherein said total energy comprises potential energy, kinetic energy and stored energy and wherein said total energy is calculated based on said measured instantaneous stored energy consumption and said measured change of the sum of potential and kinetic energy over time.

26. The method of claim 25 wherein said measuring the change of the sum of potential and kinetic energy over time comprise:
measuring the vehicle speed or distance and time traveled; and
measuring the vehicle acceleration.

27. The method of claim 26 wherein the energy efficiency of said vehicle is calculated based on equation:
EnergyEff=(f/v)−ma
wherein f is the instantaneous stored energy consumption, v is the measured vehicle speed, a is the measured vehicle acceleration and m is the vehicle mass.

28. The method of claim 26 wherein said vehicle acceleration is measured with an accelerometer mounted on said vehicle and being oriented along the longitudinal axis of the vehicle.

29. The method of claim 26 wherein said vehicle speed is measured via means for measuring the rotational speed of a wheel of said vehicle.

30. The method of claim 26 wherein said vehicle speed is measured via means for measuring the rotational speed of an impeller designed to detect the speed of said vehicle through water or air.

31. The method of claim 26 wherein said vehicle speed is measured via means for measuring the dynamic ram air pressure generated by the vehicle's motion through air.

32. The method of claim 26 wherein said vehicle speed is measured via a Global Positioning Method (GPS) receiver.

33. The method of claim 25 wherein said measuring the change of the sum of potential and kinetic energy over time comprise:
measuring the vehicle speed or distance and time traveled; and
measuring altitude.

34. The method of claim 33 wherein the energy efficiency of said vehicle is calculated based on equation:
EnergyEff=−1/v(dS/dt+(d(mgh)/dt)+(d(1/2 mv²)/dt))
wherein dS/dt is the instantaneous stored energy consumption, h is the measured altitude, v is the measured vehicle speed, m is the vehicle mass and g is the gravitational acceleration.

35. The method of claim 33 wherein altitude is measured via one of a barometric altimeter, a pressure sensor or a GPS receiver.

36. The method of claim 33 wherein altitude is measured via means for determining the location of the vehicle and a database comprising elevation information as a function of location.

37. The method of claim 25 further comprising displaying in real time the calculated energy efficiency data of the vehicle to the vehicle operator via an output device.

38. The method of claim 37 wherein said output device comprises one of a gauge, a display or a sound producing device.

39. The method of claim 37 wherein said output device further displays output data comprising at least one of “recommended speed to go”, “progress made good”, “mpg-made-good”, “estimated gallons to destination”, “instantaneous mileage”, “distance remaining”, or “average mileage per trip or segment”.

40. The method of claim 39 further comprising storing said output data for post-processing and transmitting said output data to a dispatch method for optimizing a fleet operation.

41. The method of claim 25 further comprising transmitting the calculated energy efficiency data to a vehicle control system in real time and controlling the vehicle in real time via said vehicle control system based on the calculated energy efficiency data.

42. The method of claim 25 further comprising storing the calculated energy efficiency data for post-processing.

43. The method of claim 25 wherein said stored energy comprises at least one of chemical, nuclear, thermal, wind, gasoline fuel, natural gas, petroleum, diesel, ethanol, electrical or biological energy components.

44. The method of claim 43 wherein each energy component is multiplied by a conversion factor and the result is added to the total energy.

45. The method of claim 44 wherein the conversion factor used for each stored energy component is representative of typically achieved conversion efficiency from that energy component to kinetic energy.

46. The method of claim 44 wherein the conversion factor used for each stored energy component is representative of best-case conversion efficiency from that energy component to kinetic energy.

47. The method of claim 44 wherein the conversion factor used for each stored energy component is an estimate of the conversion efficiency from that energy component to kinetic energy.

48. The method of claim 25 further comprising entering stored energy cost data, operator's time cost data or the ratio of the operator's time cost data to the stored energy stored data.
